(19) United States
(12) Patent Application Publication
(10) Pub. No.: US 2025/0167987 A1
(43) Pub. Date: May 22, 2025

(54) METHOD FOR HIDING THE IDENTITY OF COMMUNICATION DEVICES IN A CONTINUOUS GROUP KEY AGREEMENT

(71) Applicant: PQShield Ltd, Oxford (GB)

(72) Inventors: Keitaro HASHIMOTO, Oxford (GB); Shuichi KATSUMATA, Oxford (GB); Thomas PREST, Oxford (GB)

(21) Appl. No.: 19/033,305

(22) Filed: Jan. 21, 2025

Related U.S. Application Data
(63) Continuation of application No. PCT/GB2023/051932, filed on Jul. 21, 2023.

(30) Foreign Application Priority Data
Jul. 22, 2022 (GB) 2210771.8

(51) Int. Cl. H04L 9/08; H04L 9/32

(52) U.S. Cl. CPC H04L 9/0838; H04L 9/085; H04L 9/3271

(57) ABSTRACT

Methods for hiding the identity of communications devices in a continuous group key agreement are provided. A group member making a request relating to changing a group state provides a signed challenge value to a server, which signed challenge value has been signed using a group signature key. The server checks the signed challenge value to determine if the group member is in possession of the group signature key and is therefore a member of the group. As the group signature key is used, the server cannot determine the identity of the group member making the request.

### CROSS-REFERENCE TO RELATED APPLICATIONS

This application is a continuation under 35 U.S.C. § 120 of International Application No. PCT/GB2023/051932, filed Jul. 21, 2023, which claims priority to UK Application No. GB2210771.8, filed Jul. 22, 2022, under 35 U.S.C. § 119(a). Each of the above-referenced patent applications is incorporated by reference in its entirety.

### TECHNICAL FIELD

The present invention relates to a method for hiding the identity of two or more communication devices in a group communicating using a continuous group key agreement. The present invention also relates to a communication device and a program that perform a method for protecting the identity of two or more communication devices in a group communicating using a continuous group key agreement.

### BACKGROUND

Secure group messaging protocols allow groups of users to communicate in a secure and asynchronous manner. In recent years, continuous group key agreement protocols have allowed long-lived groups of parties to agree on group secrets and generate a continuous stream of fresh key material. In general, secure group messaging protocols allow group members to communicate in an end-to-end encrypted fashion, with the aim that no adversary, including a server used for transferring messages, can read the messages sent among the group members.

While the secure group messaging protocols can often protect the content of messages sent between group members, which content is encrypted using a symmetric key known only to the group members, an adversary may collect metadata, such as the identities of the sender and other group members. The metadata may be determined from any content that is exchanged that is not encrypted or based on information that can be inferred from the content that is exchanged. Knowledge of the metadata alone can have damaging repercussions. For example, it may reveal the identity of journalists or activists using a group for messaging.

It is in general challenging to protect metadata (e.g. the identity and social relationships of the group members), since knowledge of their identities is often needed by a server in order to ensure proper function of the secure group messaging protocol.

### SUMMARY

According to a first aspect of the present invention, there is provided a method for hiding the identity of two or more communication devices in a group communicating using a continuous group key agreement, wherein the two or more communication devices may communicate with each other within the group via a server, wherein the continuous group key agreement protocol comprises: generating, by one or more of the communication devices of the group, one or more proposals for updating a group state and causing the one or more proposals to be stored on the server; committing, by a committing communication device of the group, a function of zero or more of the one or more proposals stored on the server, wherein the committing communication device updates a group state stored at the committing communication device based on the committed function of zero or more proposals and, as a result of committing the function of zero or more proposals, a commit relating to the function of zero or more proposals is stored on the server, and wherein committing the function of zero or more proposals starts a new epoch for the group; downloading, by one or more downloading communication devices that are members of the group other than the committing communication device, the commit and updating a group state at each of the one or more downloading communications device based on the commit; and determining, by each of the one or more downloading communication devices, a group secret for the new epoch based on the downloaded commit to allow the one or more downloading communication devices and the committing communication device within the group to generate a common secret key for the epoch; the method for hiding the identity of the two or more communications devices comprising: a requesting communication device sending a signed challenge value to the server in connection with a request for an operation, the signed challenge value having been generated by signing a challenge value with a group signature key, wherein the requested operation comprises one of: storing one or more proposals at the server, storing a commit relating to the function of zero or more proposals at the server, and downloading the commit; the server checking the signed challenge value using a group verification key stored at the server and the challenge value; and the server performing the requested operation if the signed challenge value shows that the requesting communication device is in possession of the group signature key and the server not performing the requested operation if the signed challenge value does not confirm that the requesting communication device is in possession of the group signature key.

According to the method of the first aspect, the server uses a group verification key to verify a signature generated by a communication device making a request using a group signature key. As the keys are group keys, the server can determine that the communication device requesting to perform an operation in connection with a group state is a member of the group, thereby preventing communication devices that are not a member of the group from altering the group state. However, the server cannot determine which group member is making a request for an operation. Accordingly, the identity of the communication devices is hidden from the server.

The common secret key may be derived from the group secret for a current epoch. The group verification key may be derived from the group secret for a current epoch of the group. The group signature key may be derived from the group secret for the current epoch of the group. The current epoch of the group may be determined based on the most recent commit value stored at the server. The step of committing the function of zero or more proposals may include generating and storing, by the committing communication device, a new group verification key at the server for the new epoch. According to such embodiments, only devices within the group that possess the group secret can successfully make requests for operations to alter the group state because the group secret is needed to derive the group signature key.

In some embodiments, the requesting communication device sends the request for an operation to the server and, in response to the request, the server sends a challenge value to the communication device. The requesting communication device receives the challenge value and signs the challenge value using a group signature key for that epoch to generate a signed challenge value.

In some other embodiments, the challenge value may be derived from at least one of: contents of a proposal message being sent to the server, contents of a commit message being sent to the server, a randomness and other predetermined data. In some embodiments, the challenge value may be a pseudo-random value generated at the communication device and included in a message with a signature of the pseudo-random value under the group signature key.

In some embodiments, the group secret may be a joinerSecret. The common secret key may be appSecret or a derivative thereof. The group secret may be obtained by a communication device joining the group from a welcome message downloaded from the server. In some embodiments, the committing communication device uploads one or more welcome messages to the server when committing to the function of zero or more proposals. In such cases the zero or more proposals may include a proposal to add one or more group member to the group. The one or more welcome message uploaded to the server correspond to the one or more group members added to the group. For communication devices that are already members of the group, the group secret may be derived from a commit secret included in the commit stored on the server by the committing communication device.

The commit may contain a commit secret. The commit secret may be used by a downloading communication device to derive the group secret for the epoch associated with the commit. The group secret may be derived from the commit secret using a key derivation function.

In some embodiments, a commit received at the server from a committing communication device may be processed by the server to generate one or more member-dependent commit portions. In other embodiments, the comment received at the server from a committing communication device may contain one or more member-dependent commit portions.

The commit stored at the server may comprise a member-independent commit portion and a plurality of member-dependent commit portions associated with respective members of the group. The step of downloading, by one or more downloading communication devices that are members of the group other than the committing communication device, the commit, may comprise each downloading communication device downloading a package comprising the member-independent commit portion and a member-dependent commit portion associated with the downloading communication device.

The member-dependent commit portions may each have a respective position associated with an index or an index. Each downloading communication device may use a corresponding index to download a corresponding member-dependent commit portion. The indexes may be pseudo-randomly permuted based on a permutation key at each epoch to prevent tracking of the identity of the communication devices downloading the member-dependent commit portions. The indexes may be pseudo-randomly permuted using a shuffling algorithm that takes the permutation key as an input. In other embodiments, each index may be assigned a random value using a pseudo-random number generator that takes the permutation key as an input and the indexes may then be sorted. The indexes may be sorted using an oblivious sorting network. The permutation key may be derived by each communication device from the group secret.

The member-dependent commit portions may be stored on the server by the committing communication device with respective positions and/or indexes that have been determined by the committing communication device using the permutation key. The member-dependent commit portions may be downloaded from the server by one or more downloading communication devices using respective indexes that have been determined by each downloading communication device using the permutation key.

The communication devices may communicate with the server by establishing respective client-anonymised communication channels.

Downloading, by one or more downloading communication devices that are members of the group other than the committing communication device, the commit may include downloading the function of zero or more proposals associated with the commit from the server. Each downloading communication device may update a group state stored on the downloading communication device based on the downloaded function of zero or more proposals.

Committing, by the committing communication device of the group, the function of zero or more of the one or more proposals stored on the server may comprise sending a request to fetch proposals that are stored on the server in connection with the current epoch and sending the request for the commit to be stored on the server. Sending a request to fetch proposals may include sending a signed challenge value to the server in connection with the request to fetch proposals. The signed challenge value may have been generated by signing a challenge value with a group signature key. The server may check the signed challenge value using a group verification key stored at the server and the challenge value. The server may send the stored proposals in connection with the current epoch if the signed challenge value shows that the requesting communication device is in possession of the group signature key and the server may not send the store proposals in connection with the current epoch if the signed challenge value does not confirm that the requesting communication device is in possession of the group signature key.

The signed challenge value sent in connection with the request to fetch proposals and the signed challenge value sent in connection with the request for the commit to be stored on the server may be the same signed challenge value. In other embodiments, the committing communication device may generate separate signed challenge values for each request.

A group state stored at each communication device within the group may comprise one or more of: a group identifier, an identifier of the current group epoch, a list of group member identifiers, a list of signature verification keys corresponding to the list of group member identifiers, the group signature key for the current epoch, a group verification key for the current epoch, and a permutation key used to permute the indexes.

The group signature key and the group verification key may be a private/public key pair in a public key signature scheme.

The group signature key and the group verification key may be the same key. In such embodiments the signature may be a message authentication code.

According to a second aspect of the present invention there is provided a communication device for use in a method for hiding the identity of two or more communication devices in a group communicating using a continuous group key agreement, wherein the two or more communication devices may communicate with each other within the group via a server, wherein the communication device is configured to perform a continuous group key agreement protocol comprising: generating one or more proposals for updating a group state and causing the one or more proposals to be stored on the server; committing a function of zero or more of the one or more proposals stored on the server, wherein committing the function of the zero or more proposals includes updating a group state stored at the communication device based on the committed function of zero or more proposals and, as a result of committing the function of zero or more proposals, sending a commit related to the function of zero or more proposals for storage on the server, and wherein committing the function of zero or more proposals starts a new epoch from the group; downloading a commit and updating the group state on the communication device based on the commit; and determining a group secret for the new epoch based on a downloaded commit to allow the communication device to generate a common secret key for the epoch; the communication device being further configured to perform a method for hiding the identity of the two or more communications devices comprising: sending a signed challenge value to the server in connection with a request for an operation, the signed challenge value having been generated by signing a challenge value with a group signature key, wherein the requested operation comprises one of: storing one or more proposals at the server, storing a commit relating to the function of zero or more proposals at the server, and downloading the commit, whereby the server can check the signed challenge value using a group verification key stored at the server and the challenge value and perform the requested operation if the signed challenge value shows that the communication device is in possession of the group signature key and not perform the requested operation if the signed challenge value does not confirm that the communication device is in possession of the group signature key.

According to a third aspect of the invention there is provided one or more computer programs that, when executed by two or more communication devices and a server configured so that the two or more communication devices communicate with each other within a group via the server, causes the communication devices and the server to perform a method according to the first aspect of the invention.

According to a fourth aspect of the present invention there is provided a method performed by a communication device for hiding the identity of two or more communication devices in a group communicating using a continuous group key agreement, wherein the two or more communication devices may communicate with each other within the group via a server, wherein the communication device performs a continuous group key agreement comprising: generating one or more proposals for updating a group state and causing the one or more proposals to be stored on the server; committing a function of zero or more of the one or more proposals stored on the server, wherein committing the function of zero or more proposals includes updating a group state stored at the communication device based on the committed proposals and, as a result of committing the function of zero or more proposals, sending a commit related to the function of zero or more proposals for storage on the server, and wherein committing the function of zero or more proposals starts a new epoch from the group; downloading a commit and updating the group state on the communication device based on the commit; and determining a group secret for the new epoch based on a downloaded commit to allow the communication device to generate a common secret key for the epoch; the communication device being further configured to perform a method for hiding the identity of the two or more communications devices comprising: sending a signed challenge value to the server in connection with a request for an operation, the signed challenge value having been generated by signing a challenge value with a group signature key, wherein the requested operation comprises one of: storing one or more proposals at the server, storing a commit relating to the function of zero or more proposals at the server, and downloading the commit, whereby the server can check the signed challenge value using a group verification key stored at the server and the challenge value and perform the requested operation if the signed challenge value shows that the communication device is in possession of the group signature key and not perform the requested operation if the signed challenge value does not confirm that the communication device is in possession of the group signature key.

According to a fifth aspect of the invention there is provided a method performed by a server for use by a group of communication devices using a continuous key agreement, wherein two or more communication devices that form the group may communicate within the group via the server, wherein the continuous group key agreement comprises the server: storing one or more proposals generated by one or more of the communication devices of the group for updating group states at the communication devices; storing a commit relating to a function of zero or more proposals, wherein the commit is generated by a committing communication device committing the function of zero or more proposals stored on the server, and wherein committing the function of zero or more proposals starts a new epoch for the group; and providing for download, by one or more downloading communication devices that are members of the group other than the committing communication device, the commit to allow the one or more downloading communications device to update their group state based on the commit; the server also performing a method for hiding the identity of the two or more communications devices comprising: receiving, from a requesting communication device, a signed challenge value in connection with a request for an operation, the signed challenge value having been generated by the requesting communication device signing a challenge value with a group signature key, wherein the requested operation comprises one of: storing one or more proposals at the server, storing a commit relating to the function of zero or more proposals at the server, and downloading the commit; checking the signed challenge value using a group verification key stored at the server and the challenge value; and performing the requested operation if the signed challenge value shows that the requesting communication device is in possession of the group signature key and not performing the requested operation if the signed challenge value does not confirm that the requesting communication device is in possession of the group signature key.

In some embodiments, in response to the requesting communication device sending the request for an operation, the server sends a challenge value to the communication device.

According to a sixth aspect of the invention there is provided a server for use by a group of communication devices using a continuous key agreement, wherein two or more communication devices that form the group may communicate within the group via the server, wherein the server is configured to perform a continuous group key agreement comprising: storing one or more proposals generated by one or more of the communication devices of the group for updating group states at the communication devices; storing a commit relating to a function of zero or more proposals, wherein the commit is generated by a committing communication device committing the function of zero or more proposals stored on the server, and wherein committing the function of zero or more proposals starts a new epoch for the group; and providing for download, by one or more downloading communication devices that are members of the group other than the committing communication device, the commit to allow the one or more downloading communications device to update their group state based on the commit; the server also being configured to perform a method for hiding the identity of the two or more communications devices comprising: receiving, from a requesting communication device, a signed challenge value in connection with a request for an operation, the signed challenge value having been generated by the requesting communication device signing a challenge value with a group signature key, wherein the requested operation comprises one of: storing one or more proposals at the server, storing a commit relating to the function of zero or more proposals at the server, and downloading the commit; checking the signed challenge value using a group verification key stored at the server and the challenge value; and performing the requested operation if the signed challenge value shows that the requesting communication device is in possession of the group signature key and not performing the requested operation if the signed challenge value does not confirm that the requesting communication device is in possession of the group signature key.

### BRIEF DESCRIPTION OF THE DRAWINGS

Embodiments of the invention will now be described, by way of example only, with reference to the accompanying figures in which:

FIG. 1 is a schematic diagram showing two group members that operate communications devices that communicate with each other via a server;

FIG. 2 is a schematic diagram illustrating aspects of a continuous group key agreement protocol;

FIG. 3a is a diagram showing initial registration of a group by a group member with identity id₀;

FIG. 3b is a diagram showing initial proposals being sent by the group member with identity id₀;

FIG. 4 is a schematic diagram showing a commit operation and initialization of a new epoch;

FIG. 5 is a diagram showing shows committing, by a committing communication device of the group, zero or more of the one or more proposals stored on the server and downloading of a commit by a downloading communication device;

FIG. 6 is a schematic diagram showing components of a communication device;

FIG. 7 is a schematic diagram showing components of the server;

FIG. 8 is an illustration showing how different secrets and keys used in a metadata hiding continuous key agreement are derived from each other

FIGS. 9 to 15 show routines for achieving group messaging as described in connection with the preceding figures.

### DETAILED DESCRIPTION

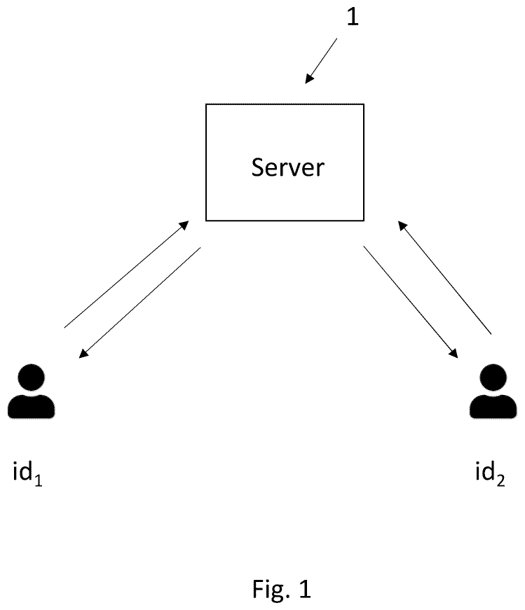

The following description describes a method for hiding the identity of two or more communication devices in a group communicating using a continuous group key agreement protocol. The two or more communication devices may communicate with each other within the group via a server. FIG. 1 is a schematic diagram showing two group members that operate communications devices having identities, id₁ and id₂, that communicate with each other via the server 1. Although the group shown in FIG. 1 includes only two group members, in general a group may have any number of group members. The group members (sometimes referred to as ‘parties’ below) communicate by uploading messages to the server 1 and downloading messages from the server 1. The parties may use a secure group messaging protocol, such as a continuous group key agreement, in order to encrypt messages exchanged between the group members. The continuous group key agreement may also provide methods for updating keys and adding and removing group members from a group conversation.

### Metadata and Metadata Leakage

Within a secure group messaging protocol sensitive information can be divided into three layers:
1^{st} layer—group secret keys and messages
2^{nd} layer—static, explicit metadata
3^{rd} layer—dynamic, implicit metadata

The first layer includes data that is kept secret by any reasonable secure group messaging protocol that is functioning as intended. The secret key or keys used for encrypting message and the message contents are protected in order to allow private communication between group members using the secure group messaging protocol.

The second and third layers can be identified as metadata. In conventional secure group messaging protocols, data in the second and third layers may only be encrypted with transport layer encryption (e.g. TLS or Noise) between a server and the participants, because the server may need to know some static metadata, such as participant identifiers, in order to facilitate a secure group messaging protocol.

Data in the second layer includes any static metadata. For example, a protocol may include the identity of the sender in clear text or the identity of a member being added to a group. Examples of this may be found in vanilla Signal and MLSPlaintext protocols. Static metadata may also include sender information and handshake messages in protocols such as the MLS standard draft (Richard Barnes et al, ‘The Messaging Layer Security (MLS) Protocol’ 2022).

Data in the third layer includes dynamic metadata, which includes any data that is implicitly leaked from the access pattern between group members and the server. For example, if a group member connects to a server using a non-anonymous protocol, such as TLS, then the server immediately learns the identity of the member. Even if an anonymous protocol is used to fetch information about a group, the exact subset of accessed information may allow correlation to a user's identity. An example of this is for group messaging protocols that arrange group members in complex data structures, such as trees.

### Continuous Group Key Agreements

Continuous group key agreements allow an evolving group of users to agree on a continuous sequence of group secrets. Continuous group key agreements allow sharing of a group secret and may implement the notions of forward secrecy and post-compromise security. Forward secrecy is a feature whereby session keys are not compromised even if long-term secrets used in the session key exchange are compromised. Similarly, post-compromise security means that future session keys are not compromised if the key for the present session is compromised.

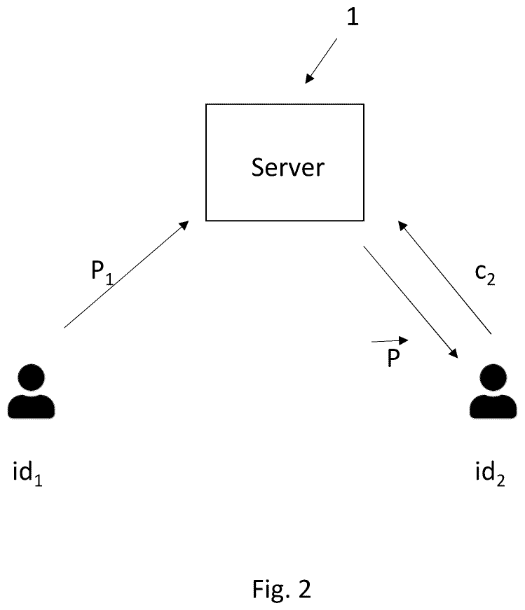

FIG. 2 is a schematic diagram illustrating aspects of a continuous group key agreement protocol. The group shown in FIG. 2 includes two group members having identities id₁ and id₂, although, as mentioned in connection with FIG. 1, in general there may be any number of members in a group with different identities. The group members communicate via the server 1. Each member of the group stores a group identifier, gid, a current epoch of the group, and a current group key. Moreover, each member stores a public key whose associated secret key is known only to themselves. The member's secret/public key pair are referred to as key material.

Each group member also has a common agreed key encapsulation mechanism that is formed of three components: a key generation function, an encapsulation function and a decapsulation function. The key generation function for a given a security parameter generates an encapsulation key and a decapsulation key. The encapsulation function, given the encapsulation key, generates a symmetric key and an encapsulation of the symmetric key under the encapsulation key. The decapsulation function, given the decapsulation key, outputs the symmetric key or an error symbol.

Each group member may use the continuous group key agreement protocol to a) add a new group member, b) remove a group member and/or c) update its keys by sending a proposal P. As illustrated in FIG. 1, a group member with identifier id₁ can send a proposal P₁ to the server 1. A group member, shown in FIG. 1 as group member with id₂, can download all or a subset of the proposals P^{→}={Pᵢ}ᵢ from the server (because the group member id₁ may upload more than one proposal or, in general, multiple group members may upload proposals in the case of larger groups) and take them into effect by transmitting a commit c₂. The transmission of the commit creates a new epoch in which the group state is updated according to the uploaded proposals, P^{→}. The commit, c₂, also updates the group secret allowing the continuous group key agreement to achieve post-compromise security.

Other group members can then download and process the commit, c₂, to update their group state to the next epoch according to the content of the proposals that were committed.

As noted above, the group secret is updated during each proposal and commit cycle. Accordingly, if a group member's key material was compromised at that epoch, this process effectively ‘heals’ the group and offers post-compromise security.

Each proposal may consist of the following elements: i) the group id, gid, identifying the group, ii) an epoch counter that specifies the group state, iii) the identity id_{P} of the member creating the proposal iv) a string indicating the action that the proposal relates to (e.g. add new group member, remove group member etc. as set out above), and v) other information that might be required for authentication.

Each commit may consist of the following elements i) a string gid identifying the group, ii) an epoch counter that specifies the group state, iii) the identity id_{c} of the member performing the commitment, iv) a ciphertext encrypting a commit secret, ct_{key}, used to update the group secret v) a signature of at least a portion of the commitment by the member performing the commitment to allow detection of tampering and vi) other information that might be required for authentication.

In some implementations, such as when using TreeKEM as the continuous group key agreement, a unitary commit may be uploaded to the server. The unitary commit may contain a ciphertext for each member of the group encrypting the key used to update the group secret. In this case, the signature to be verified may be a signature of the contents of the unitary commit such that a group member downloads the entire commit and verifies the signature of the commit contents before processing relevant parts of the commit. A potential drawback with this approach is that the size of the commit increases with the number of group members. Accordingly, for large groups the commit may become expensive in terms of data transfer and bandwidth requirements.

In some tree-based continuous group key agreements, such as SAIK (Alwen et al, 2021, ‘Server-Aided Continuous Group Key Agreement’) and CoCoA (Alwen et al, 2022, ‘CoCoA: Concurrent Continuous Group Key Agreement’), the uploaded commit is first processed by the server in order to generate a list of member-dependent commits.

In other implementations, each uploaded commit is divisible into (c₀, c^{→}), where c₀ is a member-independent commit and c^{→}=(ĉ_{id})_{id} is a list of member dependent commits. A member having an identity ‘id’ only needs to download (c₀, ĉ_{id}) from the server to advance its epoch. The value ĉ_{id} includes the value of the commit secret encrypted under the relevant group member's public key mentioned above. As the group member only needs to selectively download the relevant portion of the commit, there can be an efficiency gain. This is particularly the case when using post-quantum encryption mechanisms because post-quantum asymmetric ciphertexts tend to be much larger than classical ciphertexts.

The continuous group key agreements described above may be considered to have the following functions:

Group Creation (Create): this function initializes a new group state with a party, id, as the only member.

Proposals (Propose, act)→P: this function outputs a proposal P for the action ‘act’ that can take on the value ‘add’—idₜ, ‘rem’—idₜ, or ‘upd’. The first two actions dictate the adding or remove of a party with identity, idₜ. The last action updates the key material of a party, id.

Commit (Commit, P^{→})→(c₀, c^{→}, w^{→}): this function commits a vector of proposals P^{→} and outputs a commit (c₀, c^{→}). As mentioned above, c₀ is a member-independent commit while c^{→}=(ĉ_{id′})_{id′} is a list of member-dependent commits, where |c^{→}| is equal to the current group size. If the vector of proposals, P^{→}, contains an add proposal then the function outputs a welcome message w^{→}=(ŵ_{idt})_{idt} where idt denotes the identities of the added members. The new member may download the welcome message in order to join the group.

Process (Process, c₀, ĉ_{id}, P^{→}): this function at a communication device processes a commit (c₀, ĉ_{id}) downloaded from the server containing the associated proposals in the vector of proposals, P^{→}, and advances the internal group state of the downloading party, id, to the next epoch.

Join (Join, ŵ_{id}): this function allows a group member, id, to join the group using the welcome message ŵ_{id}. The group state of the joining party, id, is synced with any member who processes the commit made at the same epoch.

Key (key)→k: this function outputs the current group secret k.

### Overview of Metadata Hiding Continuous Group Key Agreement

The following description provides addition steps for metadata hiding continuous group key agreements. The described steps and method may be applied to any continuous group key agreement protocol of the type previously described.

Metadata hiding continuous group key agreement protocols may have one or more of the following additional properties:

Anonymous upload—a group member with identity ‘id’ can anonymously upload a proposal P or a commit (c₀, c^{→}) to the server.

Anonymous download—a group member with identity ‘id’ can anonymously download a commit (c₀, c^{→}) from the server. In implementations, in which the commit includes member-dependent commits, a group member can anonymously download a partial commit (c₀, ĉ_{id}) from the server.

Unlinkability—In a case where a member performs multiple uploads and downloads the server should not be able to links these uploads and downloads together to tract the members activities.

Group authentication—Only members of the group can upload and download from the server.

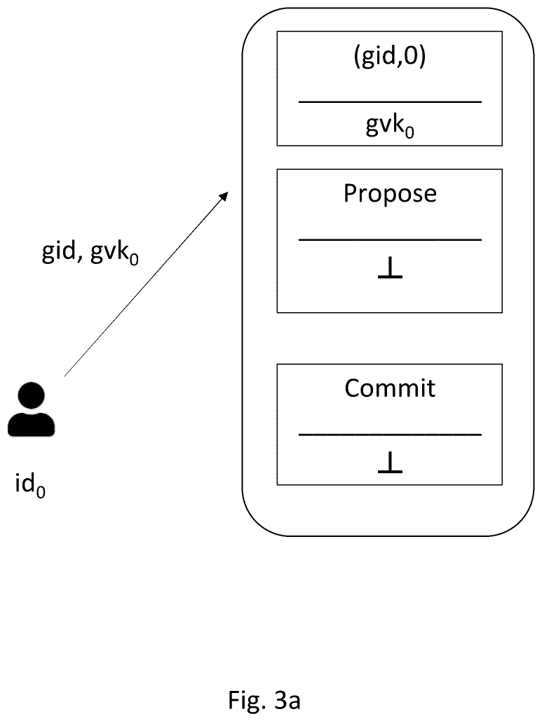

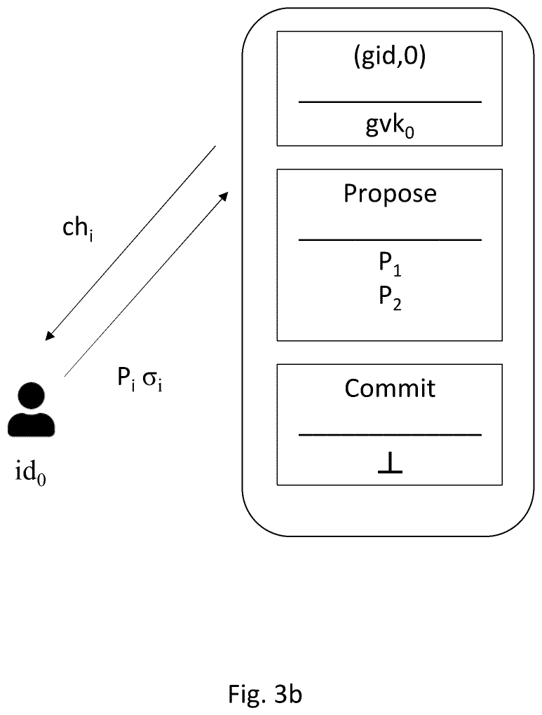

FIG. 3a is a diagram showing initial registration of a group by a group member with identity id₀. FIG. 3b is a diagram showing initial proposals being sent by the group member with identity id₀. In this embodiment, all parties set up a client anonymized authenticated channel to communicate with the server 1, except for a new member that is retrieving a welcome message from the server as will be explained in more detail below. Examples of client-anonymized authentication channels include VPN and/or an anonymized proxy, such as TOR.

During initial registration shown in FIG. 3a, a party id₀ wishes to create a group including three members (id₀, id₁, id₂). The party id₀ uses the ‘Create’ function to initialize a new group with a group identifier, gid, and a group secret key, k₀, for epoch=0. The party id₀ creates a group specific signature key using the key generation function of the key encapsulation mechanism, KeyGen (1^{k}; PRF (kₘₕ, ‘auth’))→(gvk₀, gsk₀). PRF is a pseudorandom function which takes a seed, an input secret that is derived from a metaKey described further below and a label and produces an output of arbitrary length. 1^{k} is a randomly selected binary value of k bits length that forms the seed. kₘₕ is the input secret. ‘auth’is a label associated with the anonymized authenticated channel established between the client and the server. The output of the key encapsulation mechanism forms a key pair including gvk₀ that is a group verification key and group signing key gsk₀.

gvk₀ is a group verification key. The group verification key, gvk₀, is referred to as the group statement for epoch=0. The party having id₀ uploads the group identifier and group verification key (gid, gvk₀) to the server. The server creates a new database for the group having an identity, gid.

One or more of the communication devices of the group may generate one or more proposals for updating a group state and cause the one or more proposals to be stored on the server. FIG. 3b is a schematic diagram showing a group member with identity id₀ making a proposal to add two new members having identities id₁ and id₂ to the group. In this situation there is only one group member that can upload proposals, but in later states of the group there may be multiple group members, each of which may upload proposals to the server. The group member id₀ invokes the Propose function with an input (Propose, ‘add’—idᵢ) and generates each proposal Pᵢ (i taking a value of 1 or 2). To upload Pᵢ on the server, the group member id₀ proves membership of the group, gid, by executing a membership authentication protocol with the server.

The membership authentication protocol will be used several times below. During the membership authentication protocol, the server sends a random challenge to the communication device to be authenticated, chᵢ←{0,1}^{K}. In other words, the challenge is a random binary string of length K bits, but could take other formats. The requesting communication device sends a signed challenge value, generated by signing the challenge value with the group signature key, to the server 1 along with data for a requested operation, which in this case is a request to store one or more proposals at the server. More particularly, the group member id₀ creates a signature, σᵢ←Sign (gsk₀, chᵢ), using the group's signing key gsk₀ described above. In other words, the group member id₀ signs the challenge value using a signature function under the group signing key, gsk₀. Group member id₀ sends the signature and the proposal to the server. The server checks the signed challenge value using a stored group verification key and the challenge value. In this case, the server verifies that σᵢ is a valid signature using the group statement (verification key) gvk₀ at epoch=0. The server performs the requested operation if the signed challenge value shows that the requesting communication device is in possession of the group signature key and does not perform the requested operation if the signed challenge value does not confirm that the requesting communication device is in possession of the group signature key. In this case, if the signature is valid, the proposal Pᵢ is added to a proposals database as shown in FIG. 3b. Due to the assumed unforgeability of the signature scheme, no party without the group signing key gsk₀ can impersonate a group member.

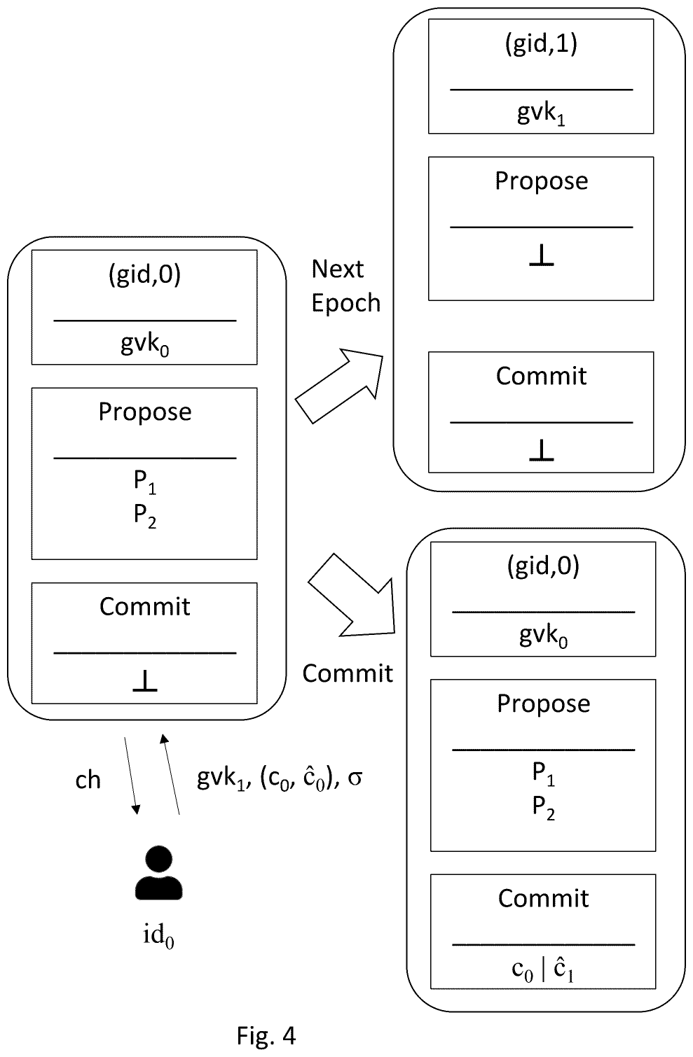

FIG. 4 is a schematic diagram showing a commit operation and initialization of a new epoch. Following the situation described in connection with FIG. 3b, group member id₀ wishes to commit the uploaded proposals, P^{→}=(Pᵢ)ᵢ where in this example i takes a value of 1 or 2, that are stored on the server in the proposals database in order to add the new group members. To do this, group member having identity id₀ invokes the commit function (Commit, P^{→}) and generates (c₀, ĉ₀, w^{→}=(ŵᵢ)ᵢ) where i takes a value of 1 or 2. Group member id₀ also generates the group key k₁ for the next epoch=1. Similar to the description in connection with FIG. 3a above, using the key encapsulation function, group member id₀ creates a group statement gvk₁ for epoch=1. To upload the commit (c₀, ĉ₀) and the welcome messages, group member id₀ requests a commit and in response performs the membership authentication protocol on a random challenge ch sent from the server using the group signature key gsk₀ to prove that he or she is a member of the group, gid. If the membership authentication protocol succeeds, the server stores the commit on the database and further creates a new entry in the database for the next epoch=1. The commit is stored by the server is a commit database.

As noted in the preceding paragraph, group member id₀ uploads welcome messages w^{→} to the server. The welcome messages are stored in a welcome database. Each party that is to become a new group member, id₁ and id₂, can respectively retrieve ŵ₁ and ŵ₂ respectively from the server. Each joining party uses function join (join, ŵᵢ) to generate the same group state as group member id₀. The new group members become group members of group, gid, at epoch=1.

Once parties id1 and id2 have become group members of group, gid, at epoch=1, they share the same group secret key, k₁, of the current epoch=1. The group members id₀, id₁ and id₂ may use the group secret key to exchange messages or may use the group secret key as an input into a key management protocol to exchange messages. The key management protocol may manage keys in a way that periodically rotates the symmetric communication key and synchronizes that communication key between the group members. The group members may also upload proposals and a commit to the database defined with respect to the group statement gvk₁.

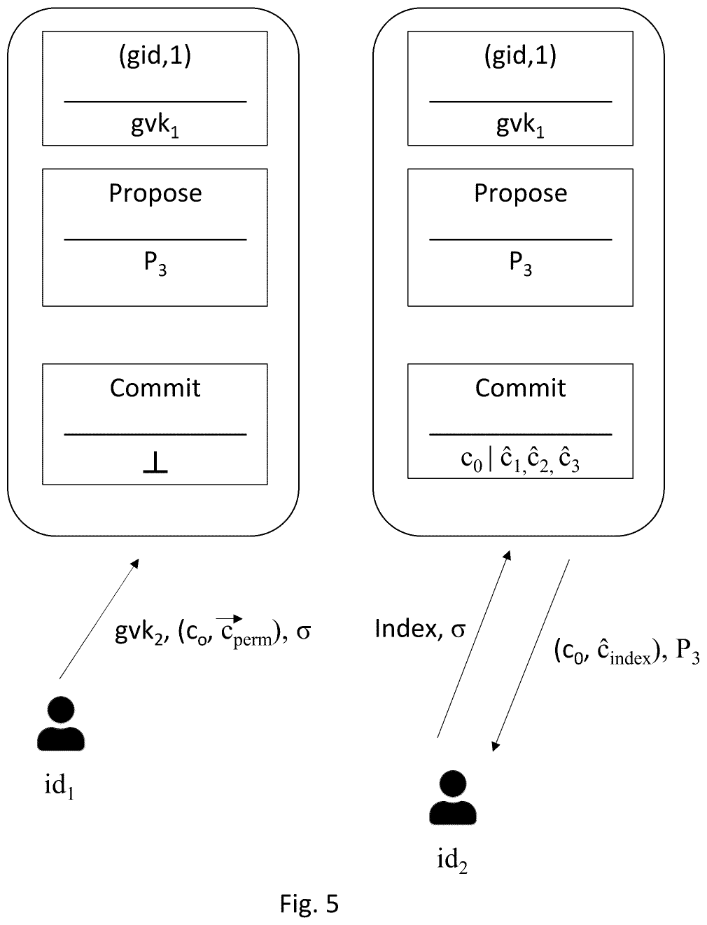

As discussed briefly above, the size of the commit message changes when the group has more than one member. FIG. 5 is a diagram that shows committing, by a committing communication device of the group, a function of zero or more of the one or more proposals stored on the server, wherein as a result of committing the zero or more proposals, a commit relating to the zero or more proposals is stored on the server. The committing communication device updates a group state stored at the committing communication device based on the committed proposals. Committing the zero or more proposals starts a new epoch. FIG. 5 also shows a group member downloading a commit.

In general, the committing communication device may accept or reject the proposals stored at the server. For example, duplicate proposals could be stored on the server that need to be resolved when committing proposals. Further, there could be conflicting proposals such as a proposal to remove a member from the group and a proposal to add the same member to the group. In general, the order of the proposals could also affect the change in group state and may be taken into account by the committing communication device. Accordingly, by determining a function of zero or more of the stored proposals, the committing communication device may commit the function of zero or more proposals and start a new epoch.

Specifically, if group member id₂ submits a proposal P₃ to the server (not shown) and group member id₁ wishes to commit this proposal (the situation shown on the left side in FIG. 5), the same procedure described above for a commit is followed. Group member id₁ invokes the commit function (Commit, p₃) and generates (c₀, c^{→}=(ĉᵢ)ᵢ)) where i takes a value between 1 and 3 because there are now three members in the group. The group member id₁ also generates and sends to the server the group statement gvk₂ for the next epoch=2.

If selective downloading in which group members only download part of the commit is not performed, then a group member id₁ can simply upload (c₀, c^{→}) to the server. The server then initiates a new column for epoch=2.

The method also comprises downloading, by one or more communication devices that are members of the group other than the committing communication device, the commit to update the communications protocol used by the group. That is to say that other group members can download the entire commit from the server as long as they can pass the membership authentication protocol described above. The one or more downloading communications device update their group states based on the commit.

As the membership authentication protocol described above uses a group key to sign the challenge value, the server cannot identify the group member accessing the server to retrieve the commit. Accordingly, the embodiments allow anonymous upload and group authentication. The embodiments may also allow anonymous download and unlinkability if the download of the commit is member independent i.e. each member downloads the same commit package.

### Selective Downloading and Permutations

As noted above, in some implementations, the commit may not be unitary and may be separated into (c₀, c^{→}), where c₀ is a member-independent commit portion and c^{→}=(ĉ_{id})_{id} is a list of member dependent commit portions. As described above, each group member may selectively download only the relevant member dependent commit portion of the commit in order to improve data efficiency. Unfortunately, if selective downloading is naively applied, this method may leak the access pattern of the group members.

When selective downloading is performed, a group member sends an index to the server as shown in FIG. 5 and receives the corresponding member dependent commit ĉ_{index} from the server. In a case that a member selectively downloads commit messages from two different epochs, the same index could be sent for both epochs. Accordingly, the server can infer that both requests were made by the same party and dynamic metadata of the party (layer 3 identified above) is not kept secret.

In a situation in which the group secret key, and thus the group member list is compromised, it is desirable that the continuous group key agreement heal. However, because the access pattern never changes, a server that has learned the member-index correspondence can permanently break anonymity when selective downloading is performed by simply looking at the same index at each epoch.

To address this problem, a pseudorandom permutation (PRP) may be used. A further implementation based on the situation shown in FIG. 5 is described in the context of a commit scheme with selective downloading. As before, a proposal P₃ has been previously uploaded by group member id₂ (not shown). A group member id₁ generates a commit (c₀, c^{→}=(ĉᵢ)ᵢ)) where i takes a value between 1 and 3. To do this, group member id₁ further deterministically generates a PRP key permKey←PRF(kₘₕ, ‘perm’) where kₘₕ is an input secret for epoch=1 that is derived from a metaKey that will be described further below and ‘perm’ is a label known to each group member. Group member id₁ creates a permuted member dependent commit c^{→} perm so that ĉᵢ is placed at an entry determined by the pseudorandom permutation, PRP(permKey, i), where i takes a value 1, 2 or 3 corresponding to the number of members in the group. Group member id₁ uploads the new group verification key (group statement) and the commit, (gvk₂, (c₀, c^{→}ₚₑᵣₘ)) to the server by performing the identification protocol using group signing key for epoch=1, gsk₁.

When another group member, such as group member id₂, performs selective download to retrieve the proposal and the commit from the server, it computes its permuted index=PRP (permKey, 2), in such a way that group member id₂ generates an identical permKey to group member id₁ and can thereby generate a corresponding permuted index. Group member id₂ can perform the identification protocol using group signature key, gsk₁, and send the generated permuted index to the server to retrieve the member dependent commit (c₀, ĉ₂) and the proposal P₃ from the server. This can be seen on the right-side of FIG. 4. Group member id₁ can invoke a function Process on input (Process, (c₀, ĉ₂), P₃) to update its group state, which is updated to epoch=2.

The above approach can, of course, be generalised to any epoch and any group member selectively retrieving a proposal or portion of a commit. The PRP key is permKey←PRF(kₘₕ, ‘perm’), where kₘₕ is derived from metaKey described below and ‘perm’ takes the value of each group members id. The group member idᵢ performing selective download computes a permuted index=PRP (permKey, i) where i is the group members id.

According to the continuous group key agreement each member of the group does not perform selective download more than once per epoch. Accordingly, the problem of repeated access using the same permuted index does not arise. As the group key is updated at each epoch, the PRP key is also updated so that the continuous group key agreement protocol satisfies forward secrecy and post-compromise security. In this way, the access patterns of group members are randomised and the server cannot derive information about group member identities by monitoring the access patterns.

### Examples of Implementations of the Continuous Group Key Agreement Protocols

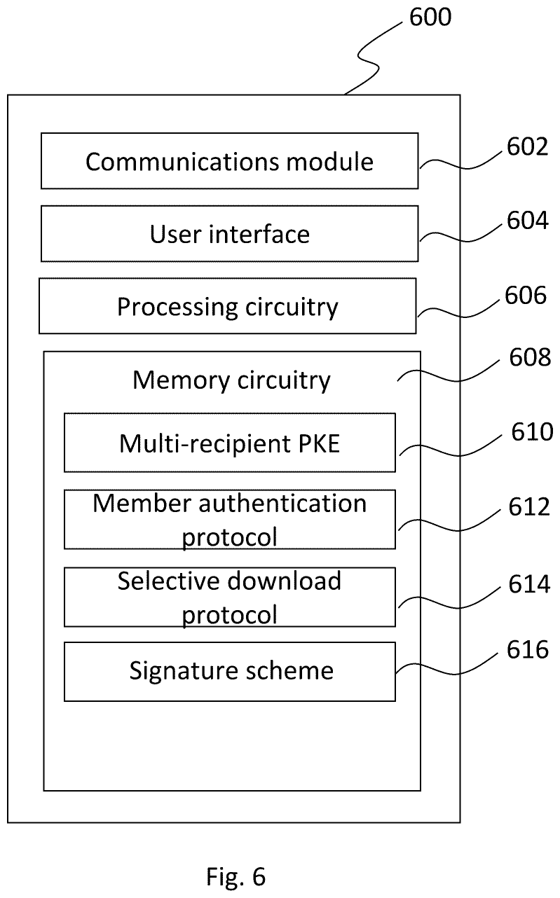

The group members in the protocols described above may be software applications on communications devices used by group members. It is noted that there may be multiple communications devices that are functionally identical with regard to the continuous group key agreement protocol, and references to the device identities, e.g. id₀, are merely used to distinguish between devices. FIG. 6 is a schematic diagram showing components of a communication device 600. Each communications device 600 may include a communications module 602 for wired or wireless communication with the other communications devices in the group via one or more servers. The communications module 602 may for example include one or more antennae for communications via a core network and a radio access network, in the case of a mobile communications device such as a smartphone. The communications device further includes a user interface 604 for receiving input from, and presenting information to, a user of the communications device 600. The user interface 604 may include any input/output devices via which the user can compose messages to be transmitted to the group and view messages received from other communications devices in the group. The user interface may for example include a touch screen in the case of a smartphone.

The communications device 600 further includes processing circuitry 606 and memory circuitry 608. The processing circuitry 606 may include one or more processing units such as a central processing unit (CPU), specialist processing units such as a digital signal processor (DSP), a subscriber identity module (SIM), a hardware-integrated trusted execution environment (TEE), and/or one or more application-specific integrated circuits (ASICs) or application-specific standard products (ASSPs). The memory circuitry 608 may include volatile random-access memory (RAM), in particular static random-access memory (SRAM) and dynamic random-access memory (DRAM), along with non-volatile memory and storage such as flash memory, an integrated solid state drive (SSD), and integral hard disk drive (HDD), and/or one or more removable storage devices.

The memory circuitry 608 also stores group state data comprising cryptographic material representing the current state of a group and instructions for implementing multi-recipient public key encryption (mPKE) 610. The instructions may implement, for example, Kurosawa's multi-recipient variant of El Gamal (Kurosawa. 2002. ‘Multi-recipient Public-Key Encryption with Shortened Ciphertext’) with the transform of Katsumata et al (Katsumata et al, 2020 ‘Scalable Ciphertext Compression Techniques for Post-quantum KEMs and their Applications’), whose decomposability property makes the transform amenable to selective downloading. In another implementation, for post-quantum security, the multi-party public key encryption may comprise one of the mPKEs proposed in (Hashimoto et al. 2021. ‘A Concrete Treatment of Efficient Continuous Group Key Agreement via Multi-Recipient PKEs’). These mPKE are: Ilum512, Bilbo640 or a SIKEp434-based mPKE.

The memory circuitry 608 also holds machine-readable instructions for implementing various functions described in the present disclosure. Code for performing a member authentication protocol 612 of the type described above is stored on the memory circuitry 608. Further code for performing a selective download protocol 614 using a pseudo-random permutation using a permutation key, permKey, of the type described above is also stored on the memory circuitry 608.

The memory circuitry 608 may store a signature scheme 610 for performing signatures and verification functions. Many different signature schemes could be used. In some implementations, it may be preferred to select a signature scheme that complements the multi-party public-key encryption scheme, either by having similar performance characteristics, being based on similar assumptions or both. Examples of signature schemes that could be used are:
The ECDSA standard, which is based on similar assumptions to the El Gamal-based mPKE and has a similar performance profile
The NIST PQC finalist Falcon (Thomas Prest et al. 2020. ‘FALCON’)
The NIST PQC finalist Dilithium (Lyubashevsky et al, 2020. ‘CRYSTALS-DILITHIUM’).
SPHINCS⁺ (Hulsing et al. 2020. ‘SPHINCS+’) and Bilbo640 are both based on conservative assumptions (hash-based assumptions and unstructured learning with errors) and both have larger communication costs than other schemes.

It is noted that there may be two signature stages in the meta-data hiding continuous group agreement method described above. A signature formed using a signature scheme as part of the commit package to allow the detection of tampering by a downloading device. The signature may appear in c₀ if using a continuous group key agreement that allows selective download of the commit value, in order to allow the receiver of the commit value to verify the party sending the commit value. Additionally, as described above, a second signature created using the group signature key is provided by a communication device when performing the membership authentication protocol. The signature schemes used in these two steps could be selected to be the same or different depending upon the implementation.

As described above, when hiding group members performing selective downloading, a pseudo-random permutation (PRP) may be performed in order to generate a permuted index for each of the set of N group members. There are at least two approaches to performing this PRP:
Shuffling: A shuffling algorithm may be provided by passing permKey (described below) into a pseudo random function. The Fisher-Yates shuffle may be used. This may be a suitable choice if cache attacks on the communication devices 500 is not a concern. If cache attacks are a concern, an oblivious shuffle algorithm may be used.
Sorting: According to this approach each member having an identity id is assigned a pseudo-random value r_{id}=H (PermKey, id). The pseudo-random values are then sorted according to the value, r_{id}. The sorting step can be done obliviously in time O(Nlog²N) using sorting networks. Assuming the function that generates the pseudo-random value, H, is collision resistant (doesn't generate two identical values) this provides a PRP over the set of N communication devices.

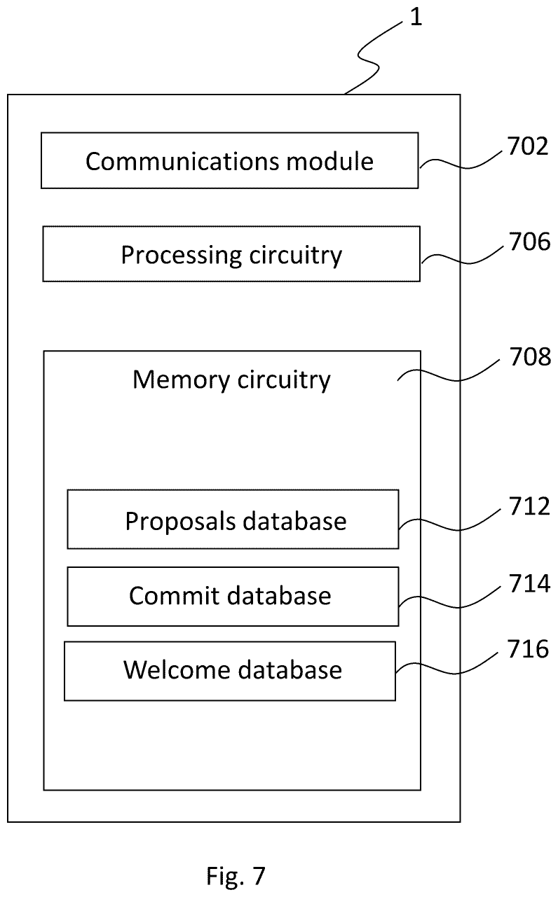

FIG. 7 is a schematic diagram showing the server 1. Similar to the communications device 600, the server 1 has a communications module 702 that allows communication with communications devices 600 using wired or wireless communication. The server 1 further includes processing circuitry 706 and memory circuitry 708. The processing circuitry 706 may include one or more processing units such as a central processing unit (CPU), neural processing unit (NPU), Graphics processing unit (GPU) or the like.

The memory circuitry 708 also holds machine-readable instructions for implementing various functions described in the present disclosure. For example, the memory may store a proposals database 712 that stores proposals received from the communications devices. The memory circuitry may store a commit database 714 that stores current epoch, the group statement (group verification key), and one or more commit from a communications device 600, where each commit closes the epoch and creates a new entry in the commit database 712. A welcome database 716 may be provided to store one or more welcome messages for group member communications devices 600 that are added during a commit process.

### Greater Detail on the Functions of Metadata Hiding Continuous Group Key Agreements

The description above provided an overview of metadata hiding techniques for continuous group key agreements. Further detail of embodiments of the method described above are provided in this section in order to avoid obscuring the overall concepts with additional details that may vary between implementations. The embodiments below implement chained mPKE as described in [Hashimoto et al. 2021. ‘A Concrete Treatment of Efficient Continuous Group Key Agreement via Multi-Recipient PKEs’]. As mentioned elsewhere in this specification, the metadata hiding techniques described herein are applicable to other continuous group key agreements.

The parties in some implementations of the continuous group key agreement may interact with an authentication service (AS) and a key service (KS). For example, the authentication service can register a new signature key for a party upon request from the party's communication device. As a result of this request, the authentication service generates a new key pair for the party and makes the public verification key from the key pair generally available. The new (secret) signature key may be provided to the party's device upon request. Accordingly, the authentication service can verify ownership of a signature key (by providing the public key of the key pair). A party may register a new signature key pair upon request. In this way, parties may determine the public keys of other group members for encrypting the contents of commit messages etc.

The key service may allow a party to upload a one-time key package to the key service for use in adding that party to a group while that party is offline. A key package may be registered on request using a party's identification (id), signature verification key (svk), and server signing key (ssk). Upon request from a party registering a key package, the key package is encrypted by the key service, which also outputs a corresponding decryption key (dk) to the registering party. Parties can also request each other's key package from the key service. The request includes the id of the party whose key package is to be retrieved and the key service returns the key package, but not the corresponding decryption key.

The server 1 may maintain a history graph. The history graph is a labelled and directed graph that acts as a symbolic representation of a group's evolution. The history graph identifies proposal nodes identified by a pointer ‘prop-id’ and commit nodes identified by a pointer ‘node-id’. When a group is created, a root commit node called the main root is created with pointer node-id=0. Each party is uniquely assigned to a commit node indicating that a party is in a group of members that processed the commit assigned to that specific commit node. The nodes' labels keep track of additional information relevant for defining security. Proposal nodes have a label that stores a proposed action and commit nodes have labels that store committed actions. Commit nodes also have labels that store the epoch's group verification key.

All nodes in the history graph store the following values:
orig: the identity of the sender who created the node i.e. the message sender
par: the parent commit node, representing the sender's current epoch

Proposal nodes further store the following values:
act ϵ (‘upd’—svk, ‘add’—kpₜ, ‘rem’—idₜ}: these values indicate the proposal action. A proposal action ‘upd’ updates the user's signature verification key, svk. A proposal action, ‘add’, adds a new member to the group with identity idₜ and key package kpₜ, A proposal action ‘rem’ removes a group member with identity idₜ.

Commit nodes further store the following values:
gid: the group identifier
epoch: the current epoch number
prop: an ordered list of committed proposals
mem: the list of a group member's identities and corresponding signature verification keys (svk).
key: the group secret

A pointer, Ptr[id] is stored in the history graph for each party id. The Ptr[id] identifies the current commit node associated with the party id. In other words, the Ptr[id] identifies the current epoch of the party. If a party is not in a group (for example because it has been removed), the pointer is set to have an error value, Ptr[id]=^{⊥}.

The server 1 offers various interfaces to parties in association with a group. These interfaces allow a party to create a group, register a proposal, register a commit, and register welcome messages. The parties can also interact with the server 1 to obtain group secret keys. All interfaces, except for Create and Join are for group members only (i.e. parties for which Ptr[id]≠^{⊥}). These functions are explored in more detail below.

Each party to the protocol holds a group state G. The group state G consists of variables including the group id, the group epoch, group membership (G.mem), which is a list of group member identifiers and associated signature verification keys, a group signature key (gsk) and group verification key (gvk), a pseudorandom permutation key (permKey) used to permute the member index as described above, and an index of the group members associated with use of the permutation key.

The server maintains three databases a proposals database, PropDB, for proposals, a commit database, ComDB, for storing commits as well as the group verification key, gvk, and a welcome database, WelDB, for welcome messages. The proposals database has separate entries that store proposals issued for each group in each epoch PropDB[gid, epoch]. These proposals, once committed, are used to move any party at epoch to epoch′=epoch+1 (i.e. to the next epoch), where the group state at each party is updated according to the proposals. The commit database stores a group verification key (also called a group statement) gvk. The group statement at each epoch is used by the server to verify that messages come from members of the group. As described above, the group members use a corresponding group signature key, gsk, to anonymously prove that they are indeed a group member. Once an entry in the commit database for a particular epoch, ComDB[gid, epoch], has a commit stored, no other commits may be stored at this epoch. The welcome database stores welcome messages. Each welcome message, WelDB[id], may be sent to a group member with identity, id.

Depending on the status of the group, the commit database can take one of the following five values:
ComDB[gid, epoch]=^{⊥}. This indicates that the epoch has not been initialized yet.
ComDB[gid, epoch]=(T, node-id). This indicates that the epoch has been initialized by a party located at the commit node identified at node-id of the history graph, and no commit has been issued for the epoch.
ComDB[gid, epoch]=((c₀, c^{→}), node-id). This indicates that the epoch has been initialized by a party located at the commit node identified at node-id of the history graph, and a commit (c₀, c^{→}) has been issued for the epoch

### Keys

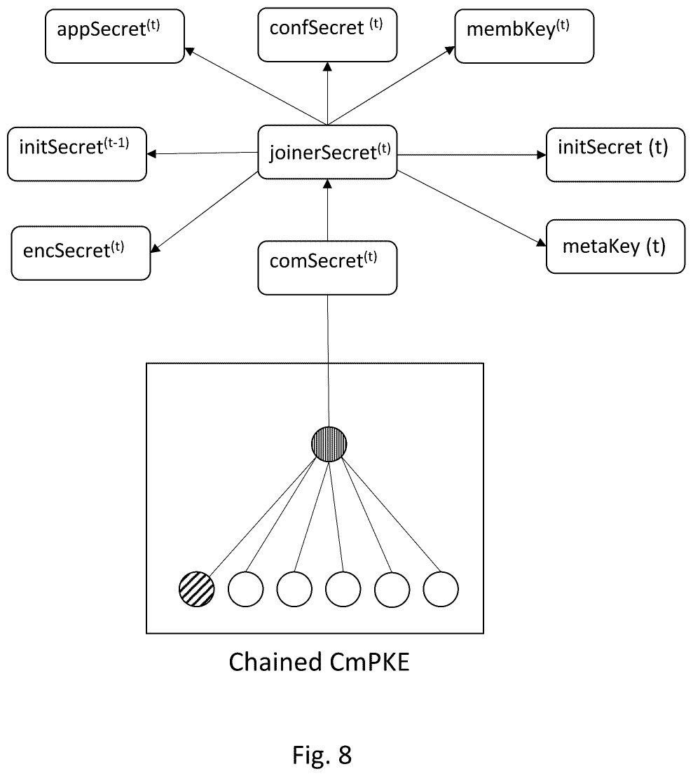

The chained (committing) multi-recipient Public Key Encryption uses several keys and secrets, which are shown in FIG. 8. Towards the bottom of the figure, a set of nodes is shown. A root node is shown with vertical hashing. This root node corresponds to a commit secret, comSecret. Below the root node, on the left-side is shown a node representing the communication device that sent a commit ending the preceding epoch. This node (representing a group member) generated the commit secret. The other nodes depicted in the group can receive the commit secret as part of the commit downloaded from the server 1 in a ciphertext encrypted using the respective node's public key. Accordingly, each of one or more downloading communication devices in a group, can determine a group secret, comSecret, for the new epoch based on the downloaded commit to allow the one or more downloading communication devices and the committing communication device within the group to generate a common secret key for the epoch.

Each epoch has a set of keys as follows:
joinerSecret is a secret sent to communication devices joining the group
appSecret is used for obtaining the epoch's shared key. Submitting appSecret to the server using the Key function returns k, which is the epochs shared key.
confKey is used to verify message access codes associated with commit and welcome packets
membKey is used to verify message access codes associated with proposal packets
encSecret is used to encrypt proposal and commit messages
metaKey is used to hide dynamic metadata as described above
initSecret is the next epoch's init secret.

Each communication device performs a procedure for generating a group secret (joinerSecret) to allow the two or more communication devices within the group to generate a common secret key (appSecret or the epoch's shared key, k). The joinerSecret is included in the Welcome message and is signed with the joining party's public key. The newly joining party may therefore retrieve the joinerSecret and derive the other keys needed to join the group at the current epoch. For other group members that are not joining the group at this epoch, the joinerSecret may be derived using a key derivation function from the initSecret of the preceding epoch and the comSecret from the commit downloaded from the server. Accordingly, each existing member of the group, each of which has access to the preceding initSecret, can also derive joinerSecret from the comSecret.

appSecret is derived from joinerSecret using a key derivation function and a tag ‘app’. The appSecret is used with the Key function at the server 1 to obtain the epoch's secret key, k, used as a source key for a symmetric encryption scheme for exchanging messages between devices or in any other application between the parties in the group requiring a common secret key.

confKey is derived from joinerSecret using a key derivation function and a tag ‘conf’. The confKey is used for message authentication codes (MAC) for commit and welcome messages. When using MAC, a signing algorithm is used to sign a commit or welcome message to generate a tag. A verifying algorithm at the communication device receiving the commit or welcome message can verify the authenticity of the message given the confKey, which the receiving communication device can also derive, and the tag. That is the receiving communication device can determine that the message and tag are not tampered with or forged. If the commit or welcome message is determined to be tampered with or forged the receiving communication device will reject the message.

membKey is derived from joinerSecret using a key derivation function and a tag ‘memb’. The membKey is used similarly to confKey, except that the MAC are used for Proposal messages rather than Commit and Welcome messages.

encSecret is derived from joinerSecret using a key derivation function and a tag ‘enc’. As noted above, this key is used to encrypt and decrypt the proposal and commit messages.

metaKey is derived from joinerSecret using a key derivation function and a tag ‘meta’. The metaKey is used to derive Keyₘₕ, which is in turn used in a key derivation function to generate the group signature key, gsk, and group verification key, gvk, used in the member authentication protocol. The value Keyₘₕ is also used to derive permKey described above for permuting the index values to disguise accesses by the communication devices when downloading commits. The use of a key, metaKey, derived from the group secret, joinerSecret, for authentication allows anonymous authentication at the server in accordance with embodiments of the invention.

initSecret is derived from joinerSecret using a key derivation function and a tag ‘init’. As mentioned above, the initSecret is used to derive the joinerSecret from the ComSecret when changing between epochs.

The key derivation function used may vary depending on implementation. In some implementations, the key derivation function may be a key derivation function based on HMAC.

### Create and Register a Group

In accordance with the description above, a party with identity id_{creator} may create a group using the Create function (Create, svk). The main group initially has a single party, id_{creator}. As described in connection with FIG. 3b, that party, id_{creator}, can add additional members by issuing proposals and committing to them. The group creator may then run a helper function, *init-states to initialize the group state. The *init-states function initializes values such as the group id, gid←{0,1}^{k}, and epoch, epoch←0.

*init-states may also use a group secret (joinerSecret) to generate a metaKey to generate a group permutation key, permKey, and an authentication key, authKey. The id_{creator} then registers the group to the server. The group creator sends the new group's group identity (gid), epoch counter (epoch), and group verification key (gvk) via a client-anonymous authenticated channel to the server 1. Upon receiving the group creation message, the server checks that the group id, gid, has not been registered yet. If the group has already been created, the process aborts and returns a message accept=false. If the group does not already exist, the server initializes the group by setting the epoch to zero and returns accept=true to the party. The server stores (gvk, ^{⊥}, ^{⊥}) as an entry in the commit database for epoch=0, comDB[gid, 0] as shown in FIG. 3a. Finally, the group creator checks the protocol result. If the group creation fails, the group creator unwinds all state changes at the group creator communication device and outputs ^{⊥} indicating a failure.

As explained above, according to the continuous group key agreement parties access the server via communication devices that are in communication with the server via a client-anonymous authenticated channel. Accordingly, the server does not output the accessing party's identity.

### Create and Publish Proposals

A party to a group with a group state having values of group identifier and epoch, (gid, epoch), can create a proposal message P by invoking the Propose function (Propose, act). The proposing party and the server 1 perform a challenge-response type membership authentication protocol that allows a party to anonymously prove valid group membership for (gid, epoch). In more detail and in accordance with the previous description, upon receiving the proposal message, the server chooses a random challenge message that is a binary value of k bits length, ch←{0,1}^{k}, and sends it to the proposing party. The proposing party then signs the challenge with its group signing key, gsk, and send the signature σ along with the information identifying the group, (gid, epoch), and the proposal, P. The proposal P has content (Propose, act), as described above, to allow adding a party to the group, removing a party from the group, or updating a party's key material. The proposal is encrypted using a key, encSecret. The server checks the entries in the commit database to see that ComDB[gid, epoch]=(gvk, ^{⊥}, ^{⊥}) and checks that the signature σ is valid with respect to gvk. If the check passes, the server stores the proposal P in an entry in the proposals database, PropDB[gid, epoch]. The server rejects the proposal if the entry in the commit database ComDB[gid, epoch] contains a commit since this indicates that a new epoch has already by created and further proposals for that epoch cannot be accepted.

### Create and Publish Commits and Welcome Messages

Initially, in order to perform a commit, a committing party requests download of a list of proposals created in association with the group state having values, (gid, epoch), by one or more group members submitting proposals as described above. The request for proposals is met by a challenge from the server using the membership authentication protocol in the same way as described in connection with publishing proposals described above. Once the server has verified the signature o of the random challenge message, the server sends a list of proposals P^{→} stored in the proposals database PropDB[gid, epoch] associated with the current epoch.

Once the committing party succeeds in fetching the vector of proposals P^{→}, the committing party creates commit and welcome messages (c₀, c^{→}, w^{→}) by invoking the Commit function (Commit, svk, P^{→}). The list c^{→} of member-dependent commit values to be downloaded by different members is randomly permuted. This procedure allows for a shuffle of the order of the members at each new epoch and makes selective downloading of the member-dependent portion of the commit unlinkable between different epochs. The committing party publishes (c₀, cₚₑᵣₘ^{→}, w^{→}) by performing two different uploads. The committing party first publishes the commit (c₀, cₚₑᵣₘ^{→}) as follows. The committing party accesses the server via a client-anonymous authenticated channel and performs the authentication protocol as described in connection with publishing proposals above. After generating the response signature σ, the committing party further generates a group verification key/group signature key pair (gvk′, gsk′) for the next epoch. The group signature key pair is generated from a metadata hiding key, kₘₕ′, which is in turn derived from metaKey for the next epoch. These values are generated, in accordance with the description of the relationship between the keys, by the committing party, which generates a new commit secret from a pseudo-random number for the next epoch, comSecret. The committing party sends (σ, gid, epoch, c₀, cₚₑᵣₘ^{→}, gvk′) to the server. If the server determines that the signature, σ, is a valid signature with respect to the group signing key of the current epoch stored in the commit database ComDB[gid, epoch]=(gvk, ^{⊥}, ^{⊥}) then the server updates the commit database with the commit values, ComDB [gid, epoch]←(gvk, c₀, cₚₑᵣₘ^{→}). If a commit was already stored for this epoch, the server rejects the commit. The server initialises the new epoch by generating a new entry in the commit database ComDB[gid, epoch+1]←(gvk′, ^{⊥}, ^{⊥}). This creates a new epoch and corresponding new entry in the proposals database to which the parties can upload new proposals. The server returns a message indicating whether the commit succeeded to the committing party.

The second upload by the committing communication device is for publishing welcome messages. The committing party accesses the server via a client-anonymised channel and uploads (idₜ, ŵ) where idₜ is an identifier of a party to be added to the group and is extracted from the welcome message for the joining party ŵ. The server stores welcome message, ŵ, in the welcome database. It should be noted that there is no member authentication protocol for this step.

### Processing a Commit Message

A member of a group, gid, that has not yet updated its communication protocol to the next/most recent epoch, can process the commit associated with the next epoch relative to the members current epoch. This process is repeated until the group member reaches the commit associated with the commit and proposals associated with the epoch immediately preceding the current epoch of the group, which allows the member to update its group state to that of the current epoch. The party and the server initially perform the membership authentication protocol to demonstrate that the party is a member of the group. Along with the signature of the challenge value, the party sends an epoch-dependent permuted index derived using permKey as described above. As described above, the index for each party varies each epoch so that the indexes between epochs are unlinkable. If the signature is a valid signature with respect to the group signing key, the server returns a list of proposals, P^{→}, stored in the proposals database, propDB [gid, epoch], the party independent commit, c₀, and the party-dependent commit for the party based on the received index, ĉ=cₚₑᵣₘ^{→}[index].

Following receipt of the list of proposals and commit values, the party processes them to update their internal state based on a commit secret, comSecret, included in the commit values.

### Joining a Group

A party can join a group by downloading a Welcome message. The joining party accesses the server using an authenticated channel. In this case, the party discloses its identity to the server. The identity of the party is used by the server to find an associated Welcome message to provide to the joining party. The server either returns a welcome message, ŵ, associated with the party's id or there is no welcome message.

Once a party receives a welcome message, the welcome message is processed allowing the joining party to retrieve the joinerSecret included in the welcome message. The joining party may then derive the other keys required to participate in the group.

Note that the welcome messages leak the receiver's identity, the key package's hash and the group size. The receiver's identity is in the clear for the server to deliver the welcome messages. The key package hash is used by the receiver to determine the decryption key to process the welcome message.

### Routines for Achieving Functions Described Above

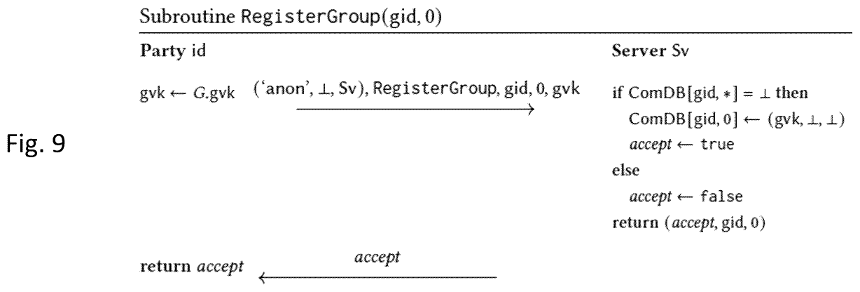

FIGS. 9 to 15 show routines for achieving the functions described above. One or more of these routines may optionally be used to implement the embodiments described above. Each figure will be briefly described below so that its relation to the methods described above can be appreciated.

FIG. 9 shows a routine RegisterGroup for registering a new group and initializing group states for the current epoch. The message exchange involves a Party id and the server Sv that are communicating via a client-anonymized authenticated channel.

Party id sends a RegisterGroup request via the client-anonymized channel to the server Sv including a group id, gid, and a group verification key, gvk. The server checks that status of the commit database for the existence of a group with id, gid, and if the group does not already exist creates an entry in the commit database having a group id, gid, and a group verification key, gvk.

The server, Sv, returns accept=true if the group registration is successful and returns accept=false otherwise.

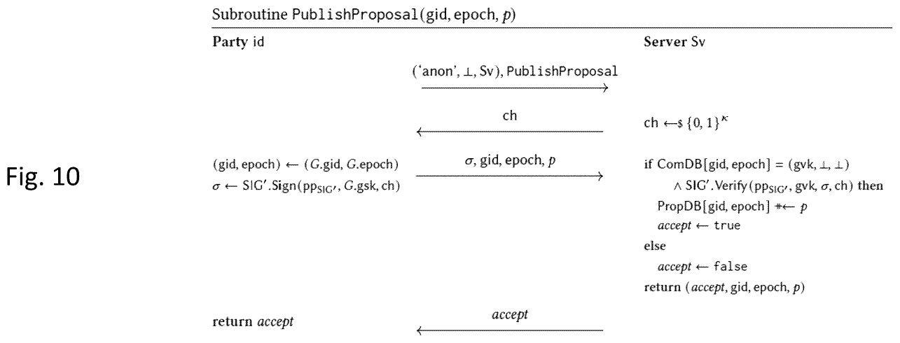

FIG. 10 shows a PublishProposal routine. As shown in FIG. 10, Party id sends a PublishProposal request to the server Sv. The communication channel is again client-anonymous and the message is addressed to server Sv.

In response to the PublishProposal request, the server returns a challenge value, ch, which is a binary string that is k bits long.

Based on a group state stored at party id, the party retrieves the group id, gid, and the epoch associated with that group. Party id signs the challenge value under the group signature key, gsk, to generate a signed challenge value. Party id then sends the signature, group id, epoch and a proposal, p to the server.

The server checks the group id and epoch to see if a database entry for that group is still open (i.e. not committed) in the Commit database. The received signature is then checked using the signature verification key, gvk stored in the Commit database. Assuming, that this check is passed, the proposal p is stored in the proposal database.

If the proposal is accepted and stored, the server returns ‘accept’=true. Otherwise, the server returns ‘accept’=false.

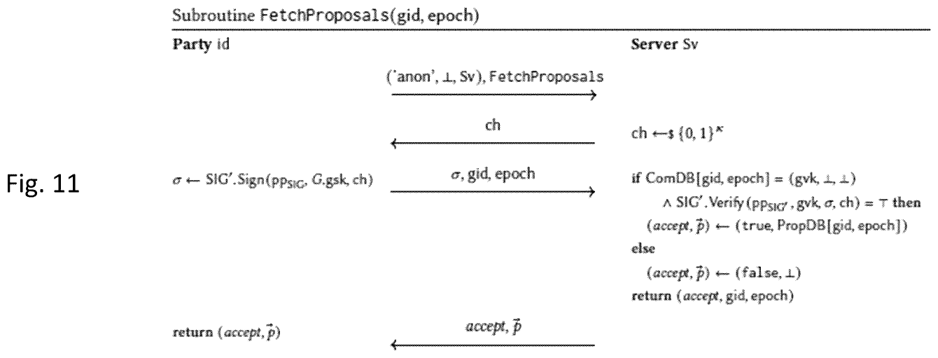

FIG. 11 shows a routine associated with a FetchProposals request. In this routine the Party id sends a FetchProposals request to the server Sv. As before, the channel is anonymous (‘anon’) and the message is addressed to server Sv.

The server returns a challenge value, ch, which is a binary string that is k bits long. Party id signs the challenge value under the group signature key, gsk, to generate a signed challenge value. The party sends the signature, group id, and epoch in reply to the challenge.

Upon receipt of the signature, group id and epoch, the server checks that the epoch is still open (i.e. not committed) in the Commit database. The signature is then checked using the signature verification key, gvk stored in the Commit database. If the checks are passed, the server returns a vector of stored proposals in connection with the group id and current epoch and an accept value=true. Otherwise, the server returns ‘accept’=false

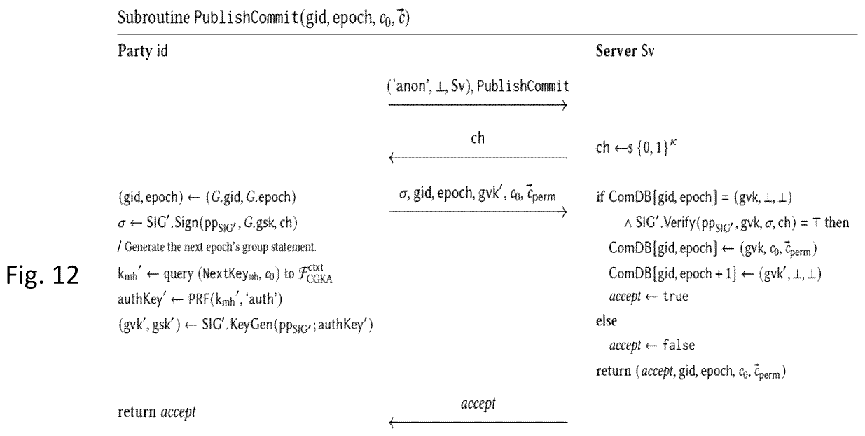

FIG. 12 shows a routine for publishing commit messages. As shown in FIG. 12, Party id sends a PublishCommit request to the server Sv. As before, the channel is anonymous (‘anon’) and the message is addressed to server Sv.

In response to the PublishCommit request, the server returns a challenge value, ch, which is a binary string that is k bits long. Based on the group state stored at party id, the party retrieves values of the group id, gid, and epoch. Party id signs the challenge value under the group signature key, gsk, to generate a signed challenge value.

Party id generates the next epoch's group statement by:
i) generating a metadata hiding key kmh′ for the next epoch.
ii) using a pseudo-random function (PRF), the metadata hiding key and a tag, ‘auth’, generating an authentication key (authkey′) for the next epoch.
iii) using a key generation function with input authkey′ generating the group signature and group verification key pair for the next epoch.

The Party id sends the signature, group id, epoch, group verification key for the next epoch, member independent commit and vector of member-dependent commit values to the server in reply to the challenge.

The server checks that the epoch for that group id is still open (i.e. not committed) in the Commit database. The signature is then checked using the signature verification key, gvk. Assuming that the checks are passed, the server updates the commit database with the member-independent and member-dependent commit values. The server creates a new entry in the ComDB for the new epoch.

If commit is successful the server returns ‘accept’=true. Otherwise, the server returns ‘accept’=false.

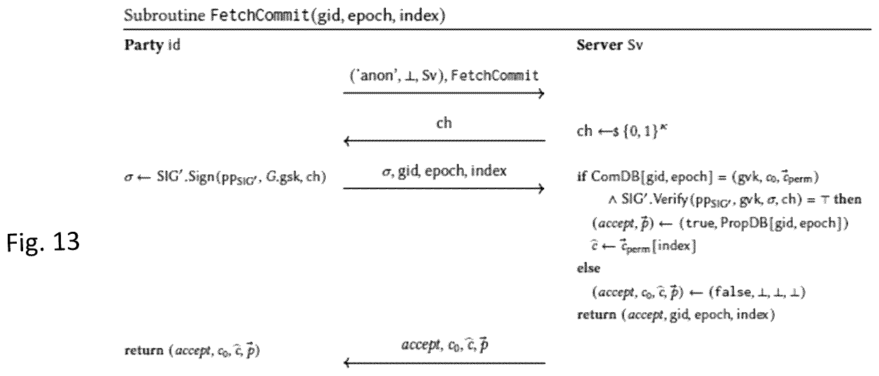

FIG. 13 shows a routine for fetching commit messages from the server. The Party id sends a FetchCommit request to the server. As before, the channel is anonymous (‘anon’) and the message is addressed to server Sv.

Server returns a challenge value, ch, which is a binary string that is k bits long. The Party id signs the challenge value under the group signature key, gsk, to generate a signed challenge value. The party sends the signature, group id, epoch, and the value ‘index’ in reply to the challenge. The value ‘index’ is created using the metadata hiding key described above (kₘₕ). A permutation key is generated using a pseudo random function, kₘₕ and a tag ‘perm’ (permKey←PRF(kₘₕ, ‘perm’)). The index is generated using the pseudo-random function, the permKey and the Party's identity, i (index=PRP (permKey, i)).

The server checks that the epoch is committed by checking the status of the group in the Commit database. The signature is then checked using the signature verification key, gvk. Assuming that the checks are passed, the server returns a vector of stored proposals in connection with the group id and an accept value. The server also returns the member-independent commit and member-dependent commit corresponding to the received index.

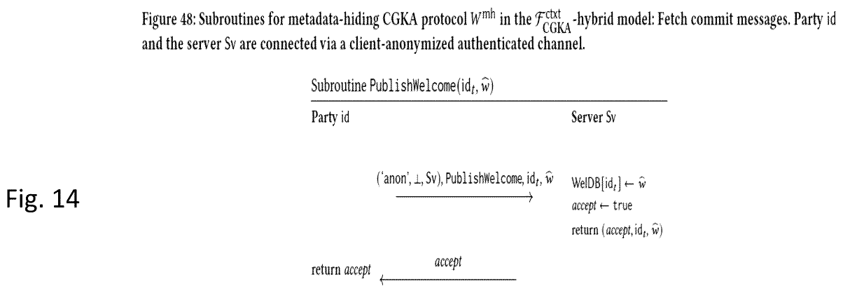

FIG. 14 shows a routine for publishing Welcome messages. As shown in FIG. 14, Party id sends a Publish Welcome request to the server Sv. The channel is anonymous (‘anon’) and the message is addressed to server Sv. The request to publish by Party id includes a party identifier, idt, of the receiving party and the welcome message to be published.

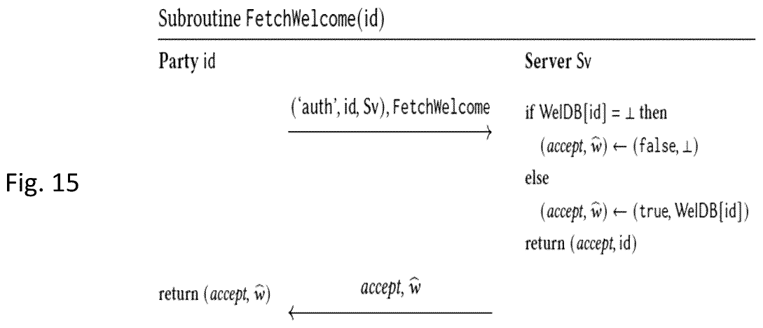

The server stores the welcome message in the Welcome database in association with the identifier idt. The server returns the value ‘accept’.FIG. 15 shows a routine for fetching Welcome messages. A Party id sends a FetchWelcome request to the server Sv. In this routine, the communication channel is not client-anonymous and the message is addressed to server Sv. The request by party id includes a party identifier, id.

The server looks for Welcome messages stored in the Welcome database in association with the party identifier, id. If no message is found the server returns ‘accept’=false. If a Welcome message is found, the server returns ‘accept’=true and the retrieved welcome message.

### Alternative Embodiments

The above embodiments are to be understood as illustrative examples of the invention. Further embodiments of the invention are envisaged.

In the examples above, when performing a commit, a two-stage process is performed. The communication device fetches proposals from the server, which requires completion the membership authentication protocol (i.e. a first challenge value is sent by the server and a signature of the first challenge value is returned by the communication device) and publication of the commit which requires a second completion of the membership authentication protocol (i.e. receipt of a second challenge value and signature of the second challenge value). In a variant, the fetching of proposals and publication of the commit could be performed based on a single membership authentication protocol with the first challenge value and signature being used to both retrieve the proposals and to publish the commit.

In the above embodiments, the publication of the proposal and commit messages is contingent on a group member passing the member authentication protocol. As described above, this involves the server sending a challenge value and the group member signing the challenge value with a group signature key, gsk. This procedure may be made non-interactive (i.e. the separate step of the server sending the challenge value may be omitted), by the group member signing the message to the server or a value derived from the message, such as a hash. For example, for a proposal request, the group member may sign the group identifier, epoch value and proposal contents, (gid, epoch, P). The server can check the signed message against the received message contents. Similarly, for a commit, the group member may sign the group identifier, epoch value and commit, (gid, epoch, c₀, c^{→}). A possible attack would be to re-send the signature-proposal pair (or signature-commit pair for commit messages) to the server again. Accordingly, the server may be modified not to accept the same proposal twice. It is recalled that the server is already configured not to allow more than one commit per epoch.

The above modification to make the commit and proposal messages non-interactive, does not work for messages from parties requesting a list of proposals or requesting download of a commit. The reason is that these messages do not have suitable message contents to sign. However, suitable contents for signature could be derived and included with a message. For example, the output of a pseudo-random number generator could be recorded as additional message content in the aforementioned request messages and signed, allowing the server to verify the signature and that the group member is in possession of the group signature key. The server may be modified to store a list of challenge values used in a given epoch and not to accept non-interactive signed challenge values that have been used previously in order to prevent replay attacks.

In the embodiments above, the group authentication protocol uses a signature on a challenge value, generated using a group signature key (private key), from the communication device. The signature is verified by the server using a group verification key (public key). In other implementations, this mechanism may be replaced by message authentication codes (MACs). As will be familiar to persons skilled in the art, MACs use a private key only. Accordingly, in such embodiments, a single private MAC key is generated from the metaKey described above and is provided to the server with each commit message in place of the group verification key, gvk′. During the membership authentication protocol, a tag of the challenge value is generated using the MAC key at the communication device and the tag is added to the relevant message in place of the signature of the challenge value. The tag may then be verified in the usual way using the identical MAC key that has been provided to the server.

The use of MAC described in the preceding paragraph has the advantage of typically being faster and the tags typically being more compact than signatures. However, the compromise is that the security guarantees are weaker. For example, if the MAC key is leaked from the server, an adversary in possession of the MAC key can inject garbage messages because they are able to pass the group member authentication protocol. This is, of course, not possible with the private/public key pair described in the embodiments.

The above method has been described with a focus on unchained mKEM (Hashimoto et al, 2021, ‘A concrete treatment of efficient continuous group key agreement via multi-recipient PKEs’). as the continuous group key agreement. In other embodiments, TreeKEM (Barnes et al, 2022, ‘The Messaging Layer Security (MLS) Protocol’ IETF work in progress) may be used in place of unchained mKEM. Some continuous group key agreements have the server pre-process the commit messages before sending them to the users, such as SAIK (Alwen et al, 2021, ‘Server-Aided Continuous Group Key Agreement’) and CoCoA (Alwen et al, 2022, ‘CoCoA: Concurrent Continuous Group Key Agreement’). The inventors expect that it is possible to apply the above concepts to these continuous group key agreements using the concepts described above, but with modifications to account for the processing required on the server.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method for hiding the identity of two or more communication devices in a group communicating using a continuous group key agreement, wherein the two or more communication devices may communicate with each other within the group via a server, wherein the continuous group key agreement protocol comprises:
generating, by one or more of the communication devices of the group, one or more proposals for updating a group state and causing the one or more proposals to be stored on the server;
committing, by a committing communication device of the group, a function of zero or more of the one or more proposals stored on the server, wherein the committing communication device updates a group state stored at the committing communication device based on the committed function of zero or more proposals and, as a result of committing the function of zero or more proposals, a commit relating to the function of zero or more proposals is stored on the server, and wherein committing the function of zero or more proposals starts a new epoch for the group;
downloading, by one or more downloading communication devices that are members of the group other than the committing communication device, the commit and updating a group state at each of the one or more downloading communications device based on the commit; and
determining, by each of the one or more downloading communication devices, a group secret for the new epoch based on the downloaded commit to allow the one or more downloading communication devices and the committing communication device within the group to generate a common secret key for the epoch;
the method for hiding the identity of the two or more communications devices comprising:
a requesting communication device sending a signed challenge value to the server in connection with a request for an operation, the signed challenge value having been generated by signing a challenge value with a group signature key, wherein the requested operation comprises one of: storing one or more proposals at the server, storing a commit relating to the function of zero or more proposals at the server, and downloading the commit;
the server checking the signed challenge value using a group verification key stored at the server and the challenge value; and
the server performing the requested operation if the signed challenge value shows that the requesting communication device is in possession of the group signature key and does not perform the requested operation if the signed challenge value does not confirm that the requesting communication device is in possession of the group signature key.

2. A method according to claim 1, wherein the requesting communication device sends the request for an operation to the server and, in response to the request, the server sends a challenge value to the communication device,
the requesting communication device receives the challenge value and signs the challenge value using a group signature key for that epoch to generate a signed challenge value.

3. A method according to claim 1, wherein the challenge value is derived from at least one of: contents of a proposal message being sent to the server, contents of a commit message being sent to the server, a randomness and other predetermined data.

4. A method according to claim 1, wherein the group signature key and group verification keys are derived from the group secret for a current epoch of the group.

5. A method according to claim 1, wherein the commit comprises a member-independent commit portion and a plurality of member-dependent commit portions associated with respective members of the group and the step of downloading, by one or more downloading communication devices that are members of the group other than the committing communication device, the commit, comprises each downloading communication device downloading a package comprising the member-independent commit portion and a member-dependent commit portion associated with the downloading communication device.

6. A method according to claim 5, wherein the member-dependent commit portions each have a respective position associated with an index or index associated with a different group member and each downloading communication device uses a corresponding index associated with a group member to download a corresponding member-dependent commit portion, wherein the indexes are pseudo-randomly permuted based on a permutation key at each epoch to prevent tracking of the identity of the communication devices downloading the member-dependent commit portions.

7. A method according to claim 6, wherein the indexes are pseudo-randomly permuted using a shuffling algorithm that takes the permutation key as an input.

8. A method according to claim 6, wherein each index is assigned a random value using a pseudo-random number generator that takes the permutation key as an input and the indexes are then sorted.

9. A method according to claim 7, wherein the permutation key is derived from the group secret.

10. A method according to claim 1, wherein the communication devices communicate with the server by establishing respective client-anonymised communication channels.

11. A method according to claim 1 wherein downloading, by one or more downloading communication devices that are members of the group other than the committing communication device, the commit includes downloading the function of zero or more proposals associated with the commit from the server.

12. A method according to claim 1, wherein the group signature key and the group verification key are a private/public key pair in a public key signature scheme.

13. A method according to claim 1, wherein the group signature key and the group verification key are the same key and the signature is a message authentication code.

14. A communication device for use in a method for hiding the identity of two or more communication devices in a group communicating using a continuous group key agreement, wherein the two or more communication devices may communicate with each other within the group via a server, wherein the communication device is configured to perform a continuous group key agreement protocol comprising:
generating one or more proposals for updating a group state and causing the one or more proposals to be stored on the server;
committing a function of zero or more of the one or more proposals stored on the server, wherein committing the function of zero or more proposals includes updating a group state stored at the communication device based on the committed function of zero or more proposals and, as a result of committing the function of zero or more proposals, sending a commit related to the function of zero or more proposals for storage on the server, wherein committing the function of zero or more proposals starts a new epoch for the group;
downloading a commit and updating the group state based on the commit; and
determining a group secret for the new epoch based on a downloaded commit to allow the communication device to generate a common secret key for the epoch;
the communication device being further configured to perform a method for hiding the identity of the two or more communications devices comprising:
sending a signed challenge value to the server in connection with a request for an operation, the signed challenge value having been generated by signing a challenge value with a group signature key, wherein the requested operation comprises one of: storing one or more proposals at the server, storing a commit relating to the function of zero or more proposals at the server, and downloading the commit, whereby the server can check the signed challenge value using a group verification key stored at the server and the challenge value, and the server can perform the requested operation if the signed challenge value shows that the communication device is in possession of the group signature key and not perform the requested operation if the signed challenge value does not confirm that the communication device is in possession of the group signature key.

15. A non-transitory computer-readable storage medium storing one or more computer programs that, when executed by two or more communication devices and a server configured so that the two or more communication devices communicate with each other within a group via the server, causes the communication devices and the server to perform a method for hiding the identity of two or more communication devices in a group communicating using a continuous group key agreement, wherein the continuous group key agreement protocol comprises:
generating, by one or more of the communication devices of the group, one or more proposals for updating a group state and causing the one or more proposals to be stored on the server;
committing, by a committing communication device of the group, a function of zero or more of the one or more proposals stored on the server, wherein the committing communication device updates a group state stored at the committing communication device based on the committed function of zero or more proposals and, as a result of committing the function of zero or more proposals, a commit relating to the function of zero or more proposals is stored on the server, and wherein committing the function of zero or more proposals starts a new epoch for the group;
downloading, by one or more downloading communication devices that are members of the group other than the committing communication device, the commit and updating a group state at each of the one or more downloading communications device based on the commit; and
determining, by each of the one or more downloading communication devices, a group secret for the new epoch based on the downloaded commit to allow the one or more downloading communication devices and the committing communication device within the group to generate a common secret key for the epoch;
the method for hiding the identity of the two or more communications devices comprising:
a requesting communication device sending a signed challenge value to the server in connection with a request for an operation, the signed challenge value having been generated by signing a challenge value with a group signature key, wherein the requested operation comprises one of: storing one or more proposals at the server, storing a commit relating to the function of zero or more proposals at the server, and downloading the commit;
the server checking the signed challenge value using a group verification key stored at the server and the challenge value; and
the server performing the requested operation if the signed challenge value shows that the requesting communication device is in possession of the group signature key and does not perform the requested operation if the signed challenge value does not confirm that the requesting communication device is in possession of the group signature key.
